(19) United States
(12) Patent Application Publication
(10) Pub. No.: US 2002/0112674 A1
(43) Pub. Date: Aug. 22, 2002

(54) Pet carrier

(76) Inventor: Sandy Lerner, Upperville, VA (US)

Correspondence Address: Poh C. Chua, Shaw Pittman, 2300 N STREET, N.W., WASHINGTON, DC, 20037-1128, US

(21) Appl. No.: 09/781,222

(22) Filed: Feb. 13, 2001

(51) Int. Cl. A01K 1/03; A01K 1/00

(52) U.S. Cl. 119/497

(57) ABSTRACT

A pet carrier having a substantially round footprint. The pet carrier comprises a carrier bottom, a cover, and a plurality of fastening devices for attaching the cover to the carrier bottom. The carrier bottom has a flat surface, a straight wall, and a curved wall. The cover of a preferred embodiment preferably has a hemispheric shape. The cover further comprises a handle and at least one air vent. In one embodiment, a hinge is provided along the top of the straight wall to join the cover. In another embodiment, the hinge is removable, such that the cover may be completely separated from the carrier bottom. In still another embodiment, the pet carrier further comprises a padded mat that rests on the flat surface. The padded mat is preferably removable and machine-washable.

This application claims the benefit of prior U.S. Design Patent Application S.N. 29/134,737 filed Dec. 29, 2000.

### BACKGROUND

1. Field of the Invention

The present invention relates generally to a pet product, and more particularly, to a pet carrier for transporting small animals.

2. Background of the Invention

Pet carriers are often used to transport pets. The use of pet carriers provides a higher level of safety and convenience to pets and people than simply carrying or attempting to lead the pet. Pet carriers are used to transport dogs, as well as all types of pets, including cats, rabbits, guinea pigs, hamsters, reptiles, birds, and ferrets.

There are many pet carriers available in the market. Listed below are some examples of pet carrier manufacturers and/or distributors and their more popular products. For example, Petmate of Arlington, Texas distributes Classic Vari-Kennel, Kennel Cab, Double-Door Deluxe Vari-Kennel, and Pet Escort; Stylette of Philadelphia, Pennsylvania offers Pet Shuttle and Value Line; Pet Zone Products, Ltd. of Cleveland, Ohio sells Cuddle-n-Carry; and Kennel Aire of Plymouth, Minnesota has Travel Aire.

Factors that are commonly considered by buyers of pet carriers include size, price, ease of assembly, workmanship, general safety features, latch security, ventilation, weather resistance, and acceptance by of the various transportation interests. Pet carriers that are available on the market today, including the specific products mentioned above, are typically equipped with a door on one end of the carriers. These block-shape prior-art pet carriers have a roughly rectangular footprint and a roughly rectangular profile. These pet carriers are nearly always used for transporting pets and for no other purposes.

The typical rectangular carrier was initially designed basically to carry dogs on airplanes. The design was first fabricated decades ago, when dogs were generally regarded as the most popular pets. At that time, transportation of pets for veterinary, grooming, and other professional services was less common than it is today. As a result, the only consideration for the design of a pet carrier at that time was basically how to carry dogs safely on an airplane.

Until recently, cats and other animals have been relatively ignored in terms pet-related of product development, advertising, and even veterinary research, owing to the apparently incorrect perception that people were more likely to spend money on dogs than on other type of companion animals. In the last decade, however, cats have surpassed dogs as the most popular pets in the United States. In addition, there is a growing awareness that people have an increased interest in other types of companion animals, including rabbits, ferrets, birds, and reptiles. As a result, the pet market is only just beginning to turn its multi-billion dollar attention to catch up with actual consumer behavior.

There are a number of disadvantages associated with the rectangular carrier. The disadvantages are due at least in part to the design philosophy of the typical rectangular-type pet carrier in that it was designed to facilitate handling by mechanized baggage-handling equipment. The typical carrier was not conceived with any regard to the animal that would use the carrier, other than a nominal gesture by making rectangular carriers of different sizes, or with any regard to the ergonomics of using the carrier, i.e., a person transporting the carrier. The disadvantages are explained below.

First, the rectangular carrier allows an unbalanced situation to occur when the animal moves around within the carrier from one end to the other. The unbalanced situation, due to a sudden shift of the animal within the carrier, can result in significant difficulty in using the carrier, even to the point where the user drops the carrier. The situation can be aggravated when the animal is heavy and/or when the user does not have much upper-body strength. To avoid dropping the carrier, the user is required to constantly anticipate any movement of the animal and to be prepared to balance the carrier accordingly. In cases where the animal is cowering in one corner of the rectangular carrier, it is often necessary for the user to reach across himself or herself and stabilize the carrier with his or her free hand to keep the carrier from tipping over and throwing the animal against the metal door. As a result, it can be extremely uncomfortable for the user and it can also be injurious to the animal and the user of the carrier.

Second, it is difficult to retrieve an animal from the rectangular carrier through the door at one end of the carrier. The animal can be located at the far end of the carrier away from the door. This means that a user must reach into the recess of the carrier to extract the animal. The situation can be worse if the animal has been frightened or otherwise severely stressed, possibly provoking the animal to bite or scratch the user. It is not possible in most of the carriers to see what the animal is doing as the door is not large enough to admit both the arms and head, so the user is unable to see the animal's reaction to his/her hands and arms. This is not an optimal approach from any point of view.

Third, the rectangular carrier has a number of design flaws that can injure the animal and/or the user. For example, the user can scratch himself or herself very badly on the plastic molding around the metal door. Furthermore, the door itself can have very sharp edges that pose substantial risks for injury to the user. In addition, the latch protrusions that secure the door through holes in the door frame are usually also sharp. Most carriers have removable screws that hold the top and bottom together; these easily come undone, with the results that the carrier can “fall apart” during use.

Fourth, the typical carriers in the market today do not provide a familiar environment to the animal being carried. The lack of familiarity of the animal with the carrier nearly always results in the animal reacting to the carrier with fear, which ultimately results in increased difficulty in transporting the animal in and retrieving the animal from the carrier. An animal is initially frightened by the unfamiliar activity of being put into the carrier. The animal is further frightened during transport and further when it is being removed from the carrier in a foreign environment where the sights, sounds, and smells are much different from those perceived at home. Often, even an otherwise gentle and well-socialized animal can be stressed by the experience of being transported in the carrier, resulting in their biting and scratching the human that tries to remove it from the carrier, or otherwise being difficult to handle.

The importance of a familiar environment to the animal cannot be overemphasized. This is because even the most domesticated animal can be stressed such that its instinct to bite and scratch will replace its normal socialized behavior. For example, even though dogs have been “domesticated” for about 50,000 years, their instinct to bite and scratch will prevail if they are sufficiently threatened by an unfamiliar environment. Cats, have been “domesticated” for only about 5,000 years. This length of time is not sufficient to change the cats' behavior in situations of stress. Other animals such as rabbits, ferrets, snakes, etc. can hardly be said to have been domesticated at all.

Accordingly, there is a need for a pet carrier that overcomes the disadvantages that exist in the prior-art pet carriers.

### SUMMARY OF THE INVENTION

The pet carrier of the present invention overcomes the disadvantages of the prior-art carriers and differs from the prior-art carriers in many aspects. First, the pet carrier of the present invention has a substantially round footprint that reduces the likelihood of an unbalanced situation. Second, the pet carrier of the present invention does not have any door: the animal can be observed or retrieved easily by tilting back or removing the cover of the carrier. Third, the pet carrier of the present invention does not have any sharp edges that can be injurious to the animal or the user. Fourth, the carrier can be used daily as the animal's sleeping quarters to increase the animal's familiarity with the carrier, replacing the need for a separate sleeping area. Other distinctions exist.

FIG. 1 shows an exemplary embodiment of the present invention, which comprises a cover, a carrier bottom, and a plurality of fastening devices that secure the cover to the carrier bottom. Suitable fastening devices include a number of latches. The cover comprises a handle and one or more air vents. The carrier bottom comprises a flat surface, a straight wall, and a curved wall. An animal resting on the flat surface of the carrier bottom is protected by the walls from winds and other elements.

In one specific preferred embodiment, each of the cover and the carrier bottom has a substantially round, D-shape footprint. The D-shape footprint comprises a straight side and a curved side. The straight side faces a user's body when the pet carrier is carried by the user by the handle, allowing the carrier to rest closely against the body of the user for transportation. The handle is secured on the cover parallel to the straight side.

In another embodiment, the pet carrier of the present invention further comprises a padded mat that rests on the flat surface of the carrier bottom. The padded mat and the carrier bottom may be used as the animal's usual sleeping quarters. The cover of the padded mat is preferably made of a washable, soft fabric. The padded mat can further comprise a washable foam. Preferably, the padded mat can be removed from the carrier bottom. In addition, the padded mat is preferably washable in a washing machine. A user can use the pet carrier with or without the padded mat.

When it is necessary to transport the animal, the animal is placed on the flat surface of the carrier bottom with or without the padded mat. Then, the cover is attached onto the carrier bottom by the fastening devices. The user can then carry the pet carrier by the handle. The straight wall of the carrier bottom faces the user or leans against one leg of the user as the pet carrier of the present invention is carried. A truly round or circular carrier, i.e., without the straight wall, would bounce against the user's leg, causing the user to carry the pet carrier in an awkward and potentially injurious manner.

At the destination, e.g., a veterinarian's office or another location, the fastening devices are disengaged. The cover is then tilted back or lifted off of the carrier bottom to remove and/or examine the pet. In one preferred embodiment, the cover can be rotated about a hinge that attaches the cover to the carrier bottom along the top of the straight wall. In another preferred embodiment, a removable hinge can allow the cover to be separated completely from the carrier bottom. In still another preferred embodiment, the handle and the fastening devices are integral to the pet carrier of the present invention. In other words, there are no loose, supplemental, or optional parts. To prevent a hyperactive or terrified pet from escaping upon the removal of the cover, a strap can be used to secure the pet within the pet carrier.

Accordingly, it the an object of the present invention to provide a pet carrier from which an animal can be easily examined or removed.

It is another object of the present invention to provide a pet carrier with greatly improved ergonomics.

It is another object of the present invention to provide a pet carrier that decreases risks of injury to the user and the animal.

It is another object of the present invention to provide a pet carrier with optimal interior shape and space, with respect to the animal.

It is another object of the present invention to provide a pet carrier that reduces stress to the animal in transport.

It is another object of the present invention to provide a pet carrier that resembles a natural hiding place or shelter for the animal.

It is another object of the present invention to provide a multi-purpose pet product, including use as the animal's sleeping area.

It is another object of the present invention to provide a pet carrier that can be easily cleaned.

It is another object of the present invention to provide a pet carrier that is easy to store.

These and other objects of the present invention are described in greater detail in the detailed description of the invention, the appended drawings, and the attached claims.

### BRIEF DESCRIPTION OF THE DRAWINGS

FIG. 1 is a schematic diagram showing the perspective view of a first preferred embodiment of the present invention.

FIG. 2 is a schematic diagram showing the front elevation view of the first preferred embodiment of the present invention.

FIG. 3 is a schematic diagram showing the back elevation view of the first preferred embodiment of the present invention.

FIG. 4 is a schematic diagram showing the first preferred embodiment of the present invention being carried by a user.

FIG. 5 is a schematic diagram showing the top plan view of the cover of the first preferred embodiment of the present invention.

FIG. 6 is a schematic diagram showing the top plan view of the carrier bottom of the first preferred embodiment of the present invention.

FIG. 7 is a schematic diagram showing the first preferred embodiment of the present invention equipped with a strap.

FIG. 8 is a schematic diagram showing the perspective view of a second preferred embodiment of the present invention.

FIG. 9 is a schematic diagram showing the perspective view of a third preferred embodiment of the present invention.

### DETAILED DESCRIPTION OF PREFERRED EMBODIMENTS

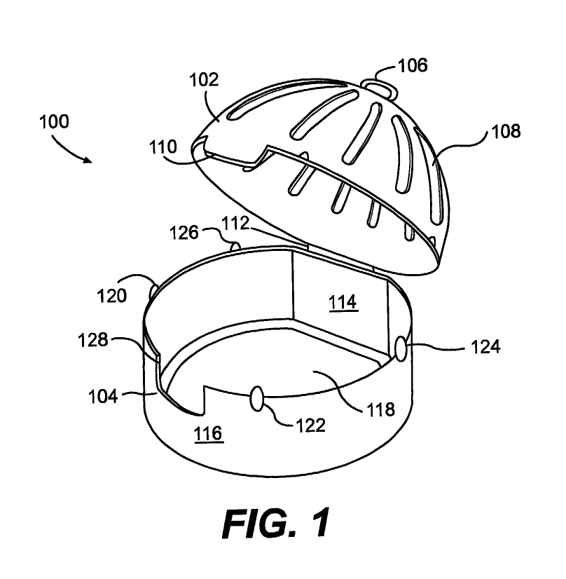

FIGS. 1-7 are schematic diagrams showing the several views of carrier 100, which is a first preferred embodiment of the present invention. Carrier 100 comprises cover 102, carrier bottom 104, and a plurality of fastening devices 120, 122, 124, and 126.

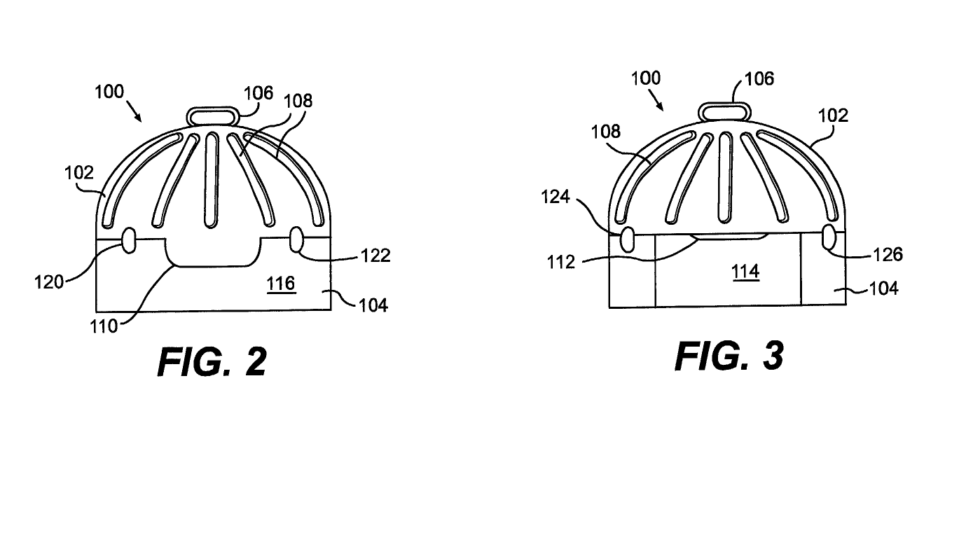

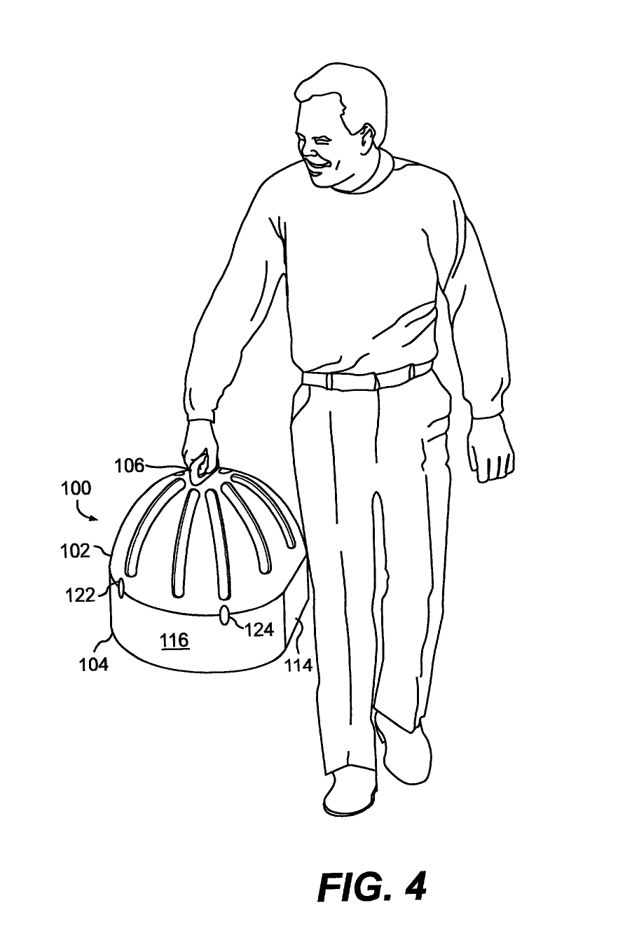

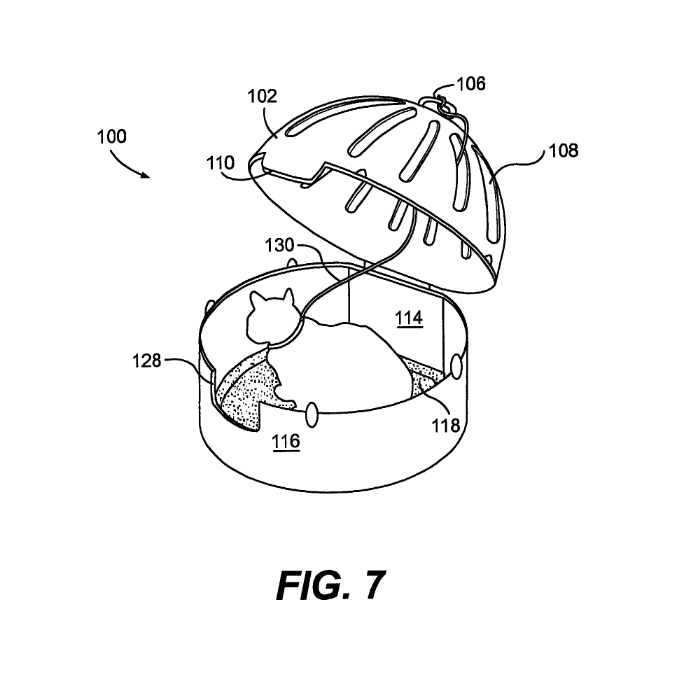

As shown in FIGS. 1-5, cover 102 has a substantially hemispheric shape. In other words, cover 102 has a dome-like profile as shown in FIGS. 2 and 3. Cover 102 may also look like one-half of an egg shell as shown in FIGS. 1 and 7. Cover 102 can further comprise tongue 110. Tongue 110 facilitates the bottom to be used as a pet bed, indented portion 128 of carrier bottom 104 mates with tongue 110, allowing the pet easy entrance/exit to the bed.

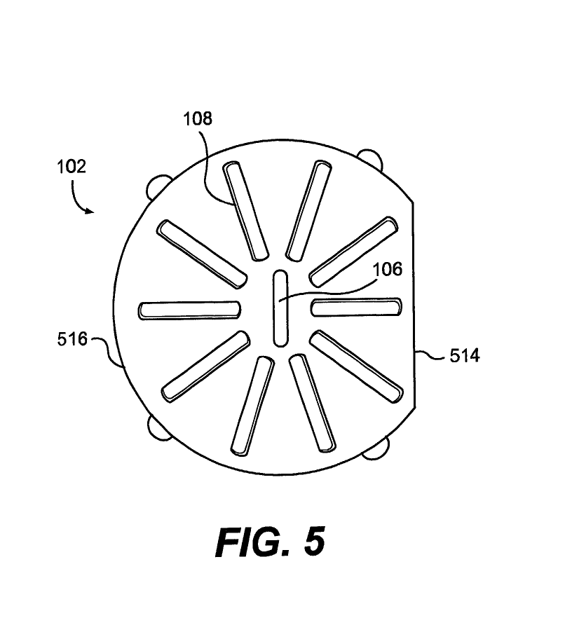

Cover 102 further comprises handle 106 and one or more air vents 108. Handle 106 can be a foldable, “attaché-style” handle that can be perpendicular to the ground when in use (as shown in FIG. 4) and parallel to the ground when at rest (not shown). Handle 106 is secured at the top extremity of cover 102. Handle 106 is preferably parallel to straight side 514 of cover 102 as shown in FIG. 5 and straight wall 114 of carrier bottom 106 as shown in FIG. 4. When a user carries carrier 100 by handle 106, handle 106 is perpendicular to the ground surface as shown in FIG. 4.

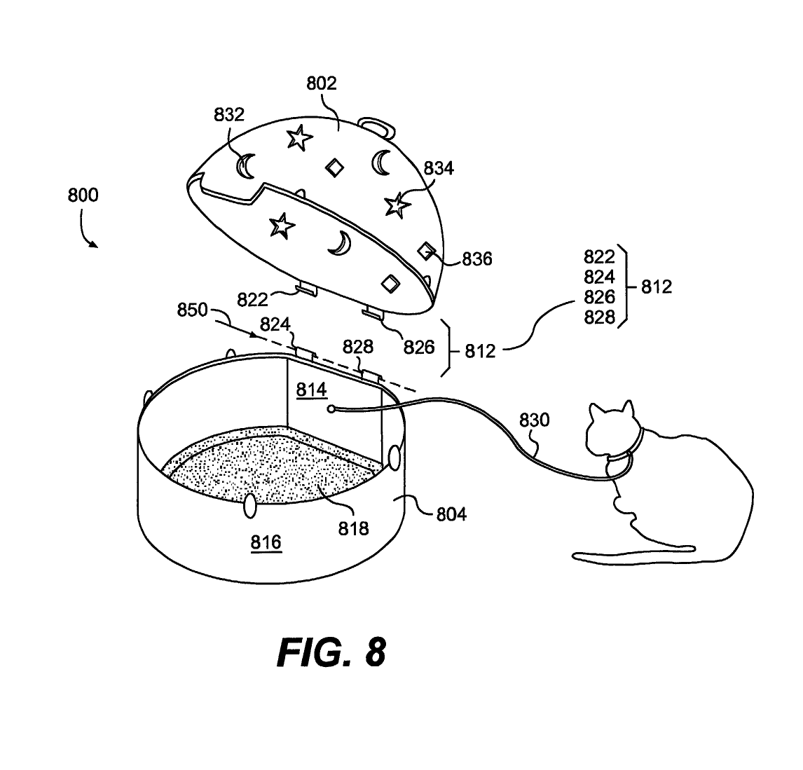

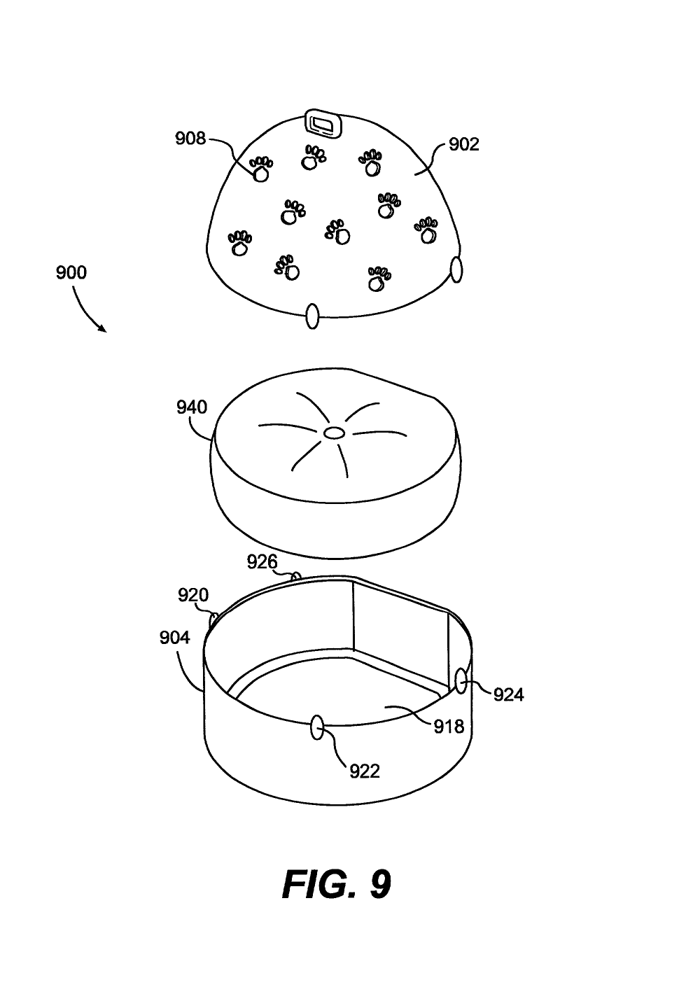

Air vents 108 can be provided in one of several shapes. For example, air vents 108 shown in FIGS. 1-5 are elongated slots extend radially from the center of cover 102. Other shapes of air vents 108 can include a circle, a square, and other designs including those shown in FIGS. 8 and 9. Cover 102 has a substantially round footprint as shown in FIG. 5. The footprint has at least one straight side 514 and at least one curved side 516.

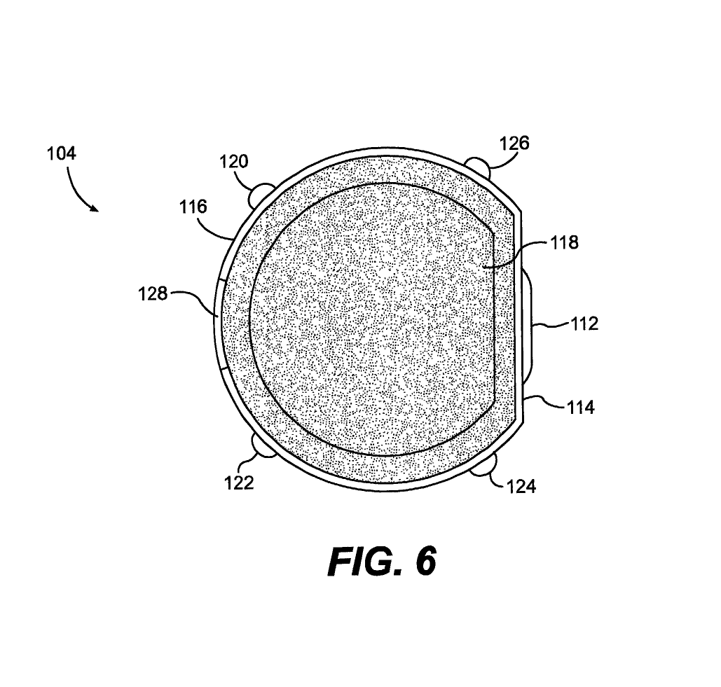

Carrier bottom 104 also has a substantially round footprint as shown in FIG. 6. The footprints of cover 102 and carrier 104 are substantially similar in shape and size (see FIGS. 5 and 6). Carrier bottom 104 has at least one straight wall 114 and at least one curved wall 116 that match straight side 514 and curved side 516, respectively. Straight wall 114 faces a user's body when carrier 100 is carried by the user as shown in FIG. 4. Carrier bottom 104 comprises flat surface 118 as shown in FIGS. 1 and 6.

Cover 102 and carrier bottom 104 can be secured to each other by a plurality of fastening devices. For example, as shown in FIGS. 2-4, fastening devices 120, 122, 124, and 126 can secure cover 102 to carrier bottom 104. Preferably, fastening devices 120, 122, 124, and 126 attach curved side 516 of cover 102 to the top of curved wall 116 of carrier bottom 104. Fastening devices 120, 122, 124, and 126 can be one of several types of latches. Suitable examples of fastening devices 120, 122, 124, and 126 include, for example, draw latches.

Hinge 112 joins cover 102 and carrier bottom 104 along straight side 514 and the top end of straight wall 114. As shown in FIGS. 1 and 7, cover 102 can rotate about hinge 112 so that an animal within carrier 100 can be placed in or removed from carrier bottom 104.

Strap 130 is an optional feature that can be used to prevent the animal from escaping. One end of strap 130 can be used to hold the animal, while the other end of strap 130 can be attached to carrier 100. For example, as shown in FIG. 7, strap 130 can be fed through air vents 108 to be secured on handle 106.

For animals such as cats and certain smaller species of dogs, carrier 100 is preferably between 16 inches and 18 inches tall (measuring vertically from flat surface 118 to top of cover 102), and the longest distance through the center of the footprint is preferably between 20 inches and 24 inches long.

The pet carrier of the present invention can be used as follows. First, cover 102 and carrier bottom 104 are separated to expose flat surface 118 of carrier bottom 104 as shown in FIG. 1. Second, animal can be secured by strap 130 as shown in FIG. 7. Third, the animal is placed on flat surface 118. Fourth, cover 102 is rotated about hinge 112 so that cover 102 rests directly above carrier bottom 104 as shown in FIGS. 2-4. Fifth, fastening devices 120, 122, 124, and 126 are engaged to secured cover 102 to carrier bottom 104. Sixth, carrier 100 is carried by the user using handle 106, with straight wall 114 faces the user's leg as shown in FIG. 4.

To observe or remove the animal, fastening devices 120, 122, 124, and 126 are first disengaged. Next, cover 102 is lifted up to rotate or pivot about hinge 112. Cover 102 may be completely removed from the carrier bottom 104 at this point. Finally, the animal can be observed or removed from carrier bottom 104.

Carrier 100 can be made of one of several types of suitable materials including various types of synthetic materials (e.g., plastics, fiber glass), light-weight metals (e.g., aluminum), and natural materials (e.g., wood). Preferably, one or both of cover 102 and carrier bottom 104 can be blow-molded using known technologies. Suitable plastics for the present invention include polypropylene and high-density copolymer.

FIG. 8 is a schematic diagram showing a perspective view of carrier 800, which is a second preferred embodiment of the present invention. Carrier 800 is similar to carrier 100 with some variations. For example, in the second preferred embodiment, hinge 812 is a removable hinge comprising units 822, 824, 826, and 828. Hinge 812 allows cover 802 and carrier bottom 804 to be completely separated. Units 824 and 828 of hinge 812 are attached to carrier bottom 804 along the top end of straight wall 814, and units 822 and 826 of hinge 812 are attached to cover 802. Hinge 812 can be engaged by lining up unit 822 to unit 824 and unit 826 to unit 828 in a straight line. Units 822, 824, 826, and 828 can then be slid or snap into each other along axis 850.

Cover 802 can have one or more air vents of different shapes and sizes. As shown in FIG. 8, the air vents can include moon shape 832, star shape 834, and diamond shape 836. Strap 830 can be provided to prevent the animal from escaping. Strap 830 can be attached to the interior of carrier bottom 804. For example, strap 830 can be secured to straight wall 814 as shown in FIG. 8. Strap 830 can also be attached to the interior face of curved wall 816.

FIG. 9 is a schematic diagram showing the perspective view of carrier 900, which is a third preferred embodiment of the present invention. Carrier 900 is similar to carrier 100 with some variations. For example, in the third preferred embodiment, carrier 900 further comprises padded mat 940. Padded mat 940 rests on flat surface 918 of carrier bottom 904. Padded mat 940 and carrier bottom 904 may be used as an animal's usual sleeping quarters. The cover of padded mat 940 is preferably made of a washable, soft fabric. Padded mat 940 can further comprise a washable foam. Preferably, padded mat 940 can be completely removed from carrier bottom 904. In addition, padded mat 940 is preferably washable in a washing machine. The best fabrics for padded mat 940 are acrylics. In particular, the fake-fur type acrylics. These fabrics are soft, washable, and they do not bleed or fade in washing. In addition, these fabrics can absorb more of the pet's scent or hair.

Cover 902 may be secured to carrier bottom 904 using a number of fastening devices, including fastening devices 920, 922, 924, and 926. Air vents 908 can have one of several designs or shapes, including a paw-print design as shown.

There are a number of motivations behind the design of the pet carrier of the present invention. The design of the present invention has a number of advantages over the prior-art pet carriers. The motivations and advantages of the present invention are explained as follows.

The first motivation is to reduce the risk of injuries to the animal and the user of the pet carrier. To that end, the pet carrier of the present invention is design to have a substantially round footprint. The substantially round footprint of the present invention does not permit the animal to create an unbalanced situation by moving from one end of the carrier to the other while the pet carrier is being carried by the user. As explained in the background section, the unbalanced situation can potentially cause one or both of the animal and the user to sustain injury. Therefore, the pet carrier of the present invention significantly reduces the likelihood of injury to the animal and the user of the pet carrier.

To further reduce the risk of injuries, the pet carrier of the present invention is provided with no door or sharp edges that are present in prior-art carriers. There are also no bolts or screws that have sharp ends in the present invention. An animal can be placed in, removed from, or examined in the pet carrier of the present invention by either tilting back or lifting off the cover.

The rectangular shape of the prior-art pet carriers, while well-suited to the baggage environment and the shape of some dogs, is ill-suited to accommodate most other types of animals, as well as being awkward to carry. This is because the handle associated with a prior-art carrier is substantially distant the user's body, causing the user to carry the pet carrier in a manner where his or her head and torso are curved away from the side of the carrier in an effort to balance the body and the pet carrier. This is not only uncomfortable, but can lead to back, neck, shoulder, and arm injury when a heavier pet is transported or when a considerable carrying distance is involved.

The second motivation behind the design of the present invention is to increase the animal's comfort level with the pet carrier so that there is little or no stress to the animal when it is being transported in the pet carrier. For example, the hemispheric cover of the present invention resembles a cave, cavern, or other natural hiding place. Furthermore, if the carrier bottom of the present invention is used as the animal's usual sleeping quarters, the pet carrier of the present invention further provides a familiar environment to the animal when the pet carrier is used to transport the animal. Because the animal is being transported in its usual sleeping quarters, it is less likely for the animal to be stressed, and therefore to act in an unusual manner that could potentially injure the animal or those handling it. Any carrier that is not familiar to the animal will provoke stress when the animal is put in the carrier, particularly if the transportation in the carrier is always associated with stress and discomfort inflicted in a veterinarian's office. The consideration of increased comfort with the pet carrier is a more important factor than the cost-saving associated with the elimination of buying a separate bed for the animal.

In nature, nearly all predators are solitary. With the exceptions of dogs and lions, most animals, e.g., cats, foxes, coyotes, mink, and ferrets, tend to hunt and live alone. As a result, these animals also tend to find refuge on their own. This is relevant as the places animals are most likely to find for rest and refuge are roughly circular. In nature, dens, burrows, holes in logs, hollows under brush, etc. are most likely to be generally small, round areas. Most animals feel more secure in small, dark areas, which conform to the shape of their bodies when they are curled up. As rectangles are not a shape found in nature, the rectangular carriers do not provide a comfortable environment for most animals.

With the present invention, the animal is not forced to leave the comfort and perceived safety of its own bed. Even if it is necessary to remove the animal from the bed, the bed is nearby, providing reassurance to the animal. Furthermore, the use of the pet carrier of the present invention is not associated with the concomitant unpleasant, unsafe, and stressful activity of attempting to remove a terrified animal cowering in the far rear of the carrier. The design of the present invention allows a person to observe or examine the animal without requiring that the animal move or be moved. Moreover, when it is necessary to place the animal in another cage, as in a prolonged visit to the veterinarian's office or in a boarding situation, the animal has its own bed and is not forced to cope with completely unfamiliar surroundings. In short, unlike the prior-art pet carriers that cause stress, the pet carrier of the present invention can function as the animal's “security blanket.”

The third motivation behind the design of the present invention is to provide a pet carrier that is easy to use. With the cover tilted back, the animal can be examined without being removed from the pet carrier. In other words, the animal can remain in whatever position the animal naturally assumed in the carrier. To further observe or examine the animal, the cover of the pet carrier is simply lifted away. There is no blind grabbing or painful pulling of arms, legs, paws, head or tail of the animal through a small and narrow door. Although some prior-art carriers have a removable top, the use of such removable top is not motivated by an effort of reducing the stress to the animal. Furthermore, the removal of the top section of prior-art carrier requires the removal of several (at least six) bolts. Larger carriers can have more than a dozen bolts which must be removed.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What I claim is:

1. A pet carrier comprising:
(a) a carrier bottom having a first substantially round footprint;
(b) a cover comprising a handle and at least one air vent, wherein the cover has a second substantially round footprint having a complementary shape and size to the first substantially round footprint; and
(c) a plurality of fastening devices for securing the cover to the carrier bottom.

2. The pet carrier of claim 1, wherein the carrier bottom further comprises an indented portion.

3. The pet carrier of claim 1, wherein at least one of the carrier bottom and the cover is made of blow-molded plastics.

4. The pet carrier of claim 1, wherein the handle is an attaché-style handle.

5. The pet carrier of claim 1, wherein the cover has a hemispheric shape.

6. The pet carrier of claim 1, wherein each of the first substantially round footprint and the second substantially round footprint has a straight side and a curved side.

7. The pet carrier of claim 1, further comprising a removable padded mat.

8. A pet carrier comprising:
(a) a carrier bottom comprising a flat surface, a straight wall, and a curved wall, wherein the carrier bottom has a first substantially round footprint;
(b) a cover comprises a handle and at least one air vent, wherein the cover has a second substantially round footprint with a straight side and a curved side, wherein the first substantially round footprint and the second substantially round footprint are substantially similar in shape and size;
(c) a hinge for connecting the straight wall of the carrier bottom and the straight side of the cover; and
(d) a latch for attaching the curved side of the cover to the curved wall of the carrier bottom.

9. The pet carrier of claim 8, wherein the hinge is a removable hinge.

10. The pet carrier of claim 8, further comprising at least one additional latch, wherein the at least one additional latch attaches the curved side of the cover to the curved wall of the carrier bottom.

11. The pet carrier of claim 8, wherein the cover has a hemispheric shape.

12. The pet carrier of claim 8, wherein the pet carrier is about 16 and 18 inches tall.

13. The pet carrier of claim 8, wherein the carrier bottom further comprising an indented portion.

14. A pet carrier comprising;
(a) a carrier bottom having a flat surface and at least one straight wall and at least one curved wall, wherein the flat surface has a first D-shape footprint;
(b) a hemispheric cover comprising a handle and at least one air vent, wherein the hemispheric cover has a second D-shape footprint that is substantially similar in shape and size to the first D-shape footprint;
(c) a hinge for connecting the at least one straight wall of the carrier bottom to the hemispheric cover, wherein the hemispheric cover pivots about the hinge; and
(d) at least one latch for attaching the at least one curved wall of the carrier bottom to the hemispheric cover.

15. The pet carrier of claim 14, further comprises a padded mat for the carrier bottom.

16. The pet carrier of claim 15, wherein the padded mat is removable.

17. The pet carrier of claim 15, wherein the padded mat is made of washable materials.

18. The pet carrier of claim 14, wherein the hinge is a removable hinge.

19. The pet carrier of claim 14, wherein at least one of the carrier bottom and the hemispheric cover is made of blow-molded plastics.

20. The pet carrier of claim 14, wherein the first D-shape footprint and the second D-shape footprint have a diameter of 20 to 24 inches long.
